(19) United States
(12) Patent Application Publication
(10) Pub. No.: US 2003/0062715 A1
(43) Pub. Date: Apr. 3, 2003

(54) Book with integral marking instruments receptacle

(76) Inventors: Steven Prescott, St. Albert (CA); Dawn Prescott, St. Albert (CA)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 10/236,272

(22) Filed: Sep. 6, 2002

Related U.S. Application Data
(60) Provisional application No. 60/326,606, filed on Oct. 1, 2001.

(51) Int. Cl. B42D 1/00; B42D 5/00

(52) U.S. Cl. 281/38

(57) ABSTRACT

A book having a plurality of sheets and a receptacle for storing a marking instrument. A first sheet of the plurality of sheets has an edge extending thereabout. The receptacle is secured to a second sheet of the plurality of sheets and protrudes from the second sheet. The edge of the first sheet extends at least partially around the receptacle, thereby enabling the receptacle to be visible and accessible to a user of the book when the book is open to the sheet. The first sheet also has a surface for receiving a marking thereon from the marking instrument and for enabling erasure of the marking therefrom with a dry cloth absent degradation to the first sheet. The first sheet, additionally, includes text corresponding to a portion of a story and/or a graphical image associated therewith.

### CROSS-REFERENCE TO RELATED APPLICATIONS

The present patent application claims the benefit of, and priority on, now pending U.S. Provisional Patent Application entitled “Activity Book Apparatus Having Writing Instruments Accessible From Each Page Thereof”, Serial No. 60/326,606, which was filed on Oct. 1, 2001.

### FIELD OF THE INVENTION

The present invention relates, generally, to the field of books and, in its various embodiments, to a book having an integral receptacle for storing a marking instrument.

### BACKGROUND OF THE INVENTION

Parents and teachers often provide children with various books, activity books, coloring books, or writing tablets to stimulate learning and imagination, to improve coordination and dexterity, and/or to occupy a child's time. Traditionally, such books and tablets have included bound volumes having paper pages with images or ruled lines thereon which define boundaries for a child to color, write, or print within. The pages may also include other images or words thereon. Together, all of the images and/or words may illustrate, or be part of, a story which appeals to children and which may be learned by the children through use of the books and tablets. The images and/or words may also teach children various morals, values, goals, ideas, or concepts.

By attempting to color within different portions of images defined by line art boundaries, a child views the pages of the book and may learn the stories associated with the images, may learn about size and proportion from the sizes and relationships of the images' various portions, and may learn colors and color coordination. Through coloring, a child may also improve imagination, eye-hand coordination, hand and fingertip control, and dexterity. Similarly, by attempting to print or write between ruled lines, a child may learn an alphabet and/or number system, may learn words, may learn the sizes, shapes and proportions of various portions of letters and numbers, and with respect to written letters, learns how to connect various letters in cursive form.

Generally, a child uses a crayon, marker, pen, pencil, or other form of coloring or writing instrument to color, print, or write on the pages of the activity book, coloring book, or tablet. Such coloring or writing instruments are, typically, stored in a container or holder which is capable of retaining the instruments therein for removal and replacement therefrom by a child when the child desires to so use them. Conventional containers or holders include, for example, boxes, sleeves or other similar articles manufactured from materials such as paper or plastic. Often, the activity book, coloring book, or tablet and the coloring or writing instruments are manufactured by different vendors, are purchased or acquired separately, and are physically separate. Because they often comprise physically separate articles, the activity books, coloring books, or tablets and the containers or holders for the coloring or writing instruments may, unfortunately, become lost or misplaced relative to one another so that one and/or the other may not be findable when a child desires to use them. Similarly, the individual instruments may become lost or misplaced as a result of a child failing to replace the instruments into the containers or holders after use because it is inconvenient to do so.

In addition to the potential for loss or misplacement of the containers or holders or of the coloring or writing instruments themselves, other difficulties exist with respect to the use of separate containers or holders for storing the coloring or writing instruments. For instance, in order for a child to remove or replace such an instrument in a container or holder, the child may have to release the book or tablet from his/her hands, thereby enabling the book or tablet to flip to another page or, potentially, to a closed position. Further, because the child may have to use both hands and reach to remove or replace a coloring or writing instrument from a separate container or holder, the child may accidentally knock over drinking glasses, plants, or other items that may be present in the same area.

As noted above, the pages of traditional activity books, coloring books, or writing tablets are manufactured from paper. Unfortunately, once a child colors or writes on the paper pages of such books or tablets with conventional crayons, markers, pens, or pencils, the pages are, typically, not re-usable, thereby requiring parents or teachers to purchase or acquire more books or tablets to replace those already colored or written upon.

A number of inventors have attempted to resolve these difficulties. However, none of the known attempts to consolidate an activity book, coloring book, or tablet with coloring or writing instruments substantially prevent the books from becoming lost or misplaced relative to the instruments. Nor do any of the known attempts enable a child to re-use the same areas of an activity book, coloring book, or writing tablet after they have been colored or written upon.

Therefore, there exists in the industry, a need for a book having storage for coloring or writing instruments which resolves the above-described difficulties and shortcoming, and other related and unrelated difficulties or shortcomings.

### SUMMARY OF THE INVENTION

Briefly described, the present invention comprises a book having a plurality of sheets and a receptacle, or holder, for storing a marking instrument, where a sheet of the plurality of sheets extends at least partially around the receptacle enabling the receptacle to be visible to a user of the book when the book is open to the sheet. More particularly, in accordance with one embodiment, the present invention comprises a book including a plurality of sheets and a receptacle. The plurality of sheets includes a first sheet having an edge extending therearound. The receptacle is secured to a second sheet of the plurality of sheets and protrudes from the second sheet. A portion of the edge of the first sheet is configured to extend at least partially around the receptacle. The first sheet, preferably, has a surface for receiving a marking thereon from the marking instrument and for enabling erasure of the marking therefrom with a dry cloth. The first sheet is also, preferably, positionable in a position substantially adjacent the second sheet with the receptacle being visible to a user when the first sheet resides in such position. Additionally, when the first sheet resides in such position, the receptacle is accessible to a user absent movement of the first sheet. Further, the first sheet includes text corresponding to a portion of a story. Still further, the first sheet includes a graphical image associated with the story.

The present invention, according to another embodiment, comprises a plurality of sheets having a first sheet with a surface adapted to receive a marking from a marking instrument and to enable erasure of the marking with a dry cloth. The present invention further comprises a holder for storing a marking instrument, where the holder is secured to a second sheet of the plurality of sheets. The first sheet, preferably, has a shoulder for receiving said holder. The shoulder is, preferably, positionable to reside substantially adjacent to the holder and to extend at least partially around the holder. The first sheet also, preferably, includes text corresponding to a portion of a story and a graphical image associated with the story. The surface of the first sheet is also, preferably, a wipe-on, wipe-off surface. Additionally, the first sheet is, preferably, positionable in a position substantially parallel to the second sheet with the holder being visible to a user adjacent the shoulder when the first sheet is in such position. Further, the holder is accessible to the user absent movement of the first sheet when the first sheet is in such position.

In accordance with still another embodiment, the present invention comprises a plurality of sheets with a first sheet of the plurality of sheets defining an opening extending therethrough and a receptacle for storing a marking instrument, where the receptacle is secured to a second sheet of the plurality of sheets and protrudes from the second sheet. The receptacle extends at least partially through the opening when the first sheet resides in a position substantially adjacent to the second sheet. The first sheet has, preferably, a surface for receiving a marking from the marking instrument and for enabling erasure of the marking with a dry cloth. The receptacle is, preferably, accessible to a user absent movement of the first sheet when the first sheet resides in such position. The opening and the receptacle, also preferably, have shapes cooperative to enable the opening to receive the receptacle at least partially therethrough. Further, the opening, preferably, enables the receptacle to be viewable by a user through the opening.

The present invention, according to still another embodiment, comprises a first book configured to present a first story to a user and a second book configured to present a second story to a user. Each book includes a first cover, a second cover, a sheet intermediate the first and second covers, and a holder for receiving a marking instrument, where the holder is secured to the second cover. The intermediate sheet has a shape adapted to extend at least partially around the holder. Preferably, the sheet includes a surface adapted to receive a marking from the marking instrument and to enable erasure of the marking with a dry cloth. Also preferably, the sheet has text or line art thereon.

The book of the present invention enables a user to view and access the receptacle storing a marking instrument without having to turn a sheet. By securing the receptacle to a sheet of the book, the risk of loss or misplacement of the receptacle is eliminated. Also, the risk of loss or misplacement of the marking instrument is minimized since the receptacle is readily accessible to the user for removal and replacement of the marking instrument.

Therefore, an object of the present invention is to present and teach a story to a user.

Another object of the present invention is to teach a user about size and proportion through the sizes and relationships of various portions of images associated with a story.

Still another object of the present invention is to teach colors and color coordination to a user.

Still another object of the present invention is to improve a user's imagination.

Still another object of the present invention is to enhance a user's eye-hand coordination.

Still another object of the present invention is to increase a user's dexterity.

Still another object of the present invention is to teach an alphabet and/or a number system to a user.

Still another object of the present invention is to teach the sizes, shapes, and proportions of alphabet letters and/or numbers to a user.

Still another object of the present invention is to teach words to a user.

Still another object of the present invention is to introduce a user to animals and/or to teach the user about animals.

Still another object of the present invention is to provide a book having integral storage for a marking instrument.

Still another object of the present invention is to provide a book having storage for a marking instrument which is readily viewable and accessible to the book's user regardless of the sheet to which the book is open.

Still another object of the present invention is to enable a user to re-use a sheet of the book after marking thereon.

Still another object of the present invention is to allow a user to erase a marking on a sheet of the book absent degradation to the sheet.

Still another object of the present invention is to reduce the possible loss or misplacement of a marking instrument storage container relative to the book.

Still another object of the present invention is to minimize the risk of loss or misplacement of a marking instrument relative to the book.

Other objects, features, and advantages of the present invention will become apparent upon reading and understanding the present specification.

### BRIEF DESCRIPTION OF THE DRAWINGS

FIG. 1 displays a front, pictorial, perspective view of a book, according to a first embodiment of the present invention, in an open state or condition.

FIG. 2 displays a front, pictorial, plan view of the book of FIG. 1 in a closed state or condition.

FIG. 3 displays a top, pictorial, plan view of the book of FIG. 1 in a closed state or condition.

FIG. 4 displays a bottom, pictorial, plan view of the book of FIG. 1 in a closed state or condition.

FIG. 5 displays a front, pictorial, plan view of the book of FIG. 1 in an open state or condition, opened to reveal a first intermediate sheet thereof.

FIG. 6 displays a front, pictorial, plan view of the book of FIG. 1 in an open state or condition, opened to reveal a second intermediate sheet thereof.

FIG. 7 displays a front, pictorial, plan view of the book of FIG. 1 in an open state or condition, opened to reveal the inside surface of the back cover thereof.

FIG. 8 displays a pictorial, plan view of an edge of a sheet of the book of FIG. 1.

FIG. 9 displays a front, pictorial, perspective view of a book, according to a second embodiment of the present invention, in an open state or condition.

FIG. 10 displays a front, pictorial, perspective view of a book, according to a third embodiment of the present invention, in an open state or condition.

FIG. 11 displays a front, pictorial, plan view of an alternative receptacle for the book of FIGS. 1, 10, and 11.

FIG. 12 displays a right side, pictorial, elevational view of the alternative receptacle of FIG. 11, showing marking instruments stored therein.

FIG. 13 displays a pictorial view of a collection of books substantially similar to that of FIG. 1 having different stories.

### DETAILED DESCRIPTION OF THE PREFERRED EMDODIMENTS

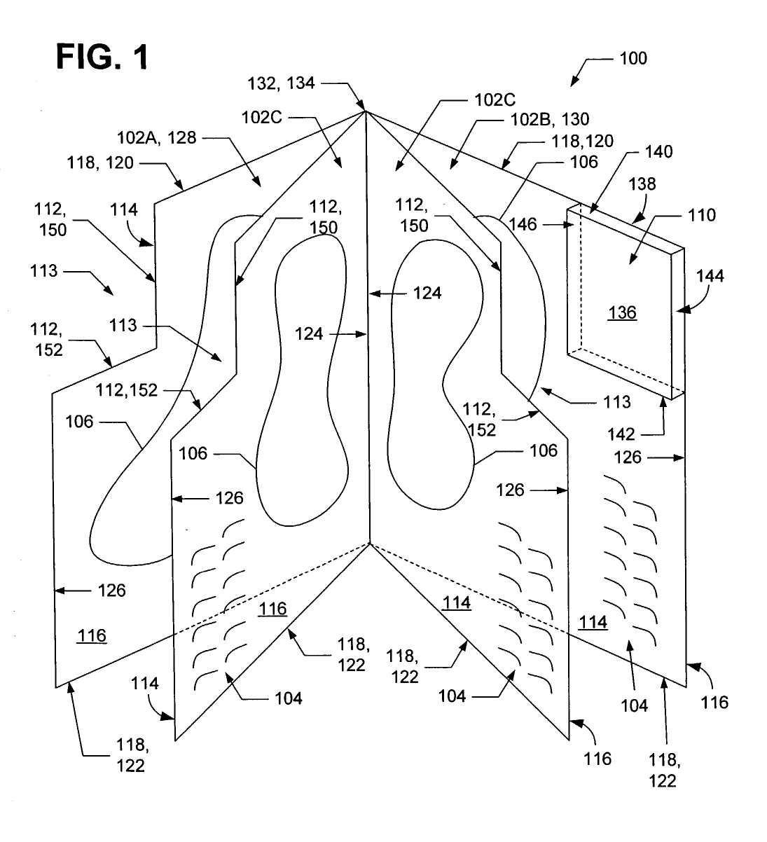

Referring now to the drawings in which like numerals represent like elements or steps throughout the several views, FIG. 1 displays a front, pictorial, perspective view of a book 100, according to a first embodiment of the present invention, in an open state or condition. The book 100 presents a story to the book's user (e.g., a child) through the book's inclusion of a plurality of sheets 102 having textual passages 104 (also sometimes referred to herein as “text 104”) representative of portions of the story and/or having graphical images 106 (also sometimes referred to herein as “illustrations 106”), generally, but not necessarily, associated with or corresponding to the textual passages 104. The illustrations 106, preferably, include line art images which may be marked on or colored by the user, thereby inducing the user to spend time reviewing the book's sheets 102 and to read, understand, and absorb the textual passages 104 while marking or coloring on the illustrations 106. Alternatively, the illustrations 106 may include non-line art images or a combination of line art and non-line art images.

The book 100 further includes a plurality of marking instruments 108 and a receptacle 110 (also sometimes referred to herein as a “holder 110” or “storage container 110”) which is secured to the book 100 and which stores the marking instruments 108 when they are not in use. The marking instruments 108 enable the book's user, through use thereof, to mark, draw, color, print, or write (also sometimes referred to herein, collectively, as “marking”) on the sheets 102 and the line art images. Preferably, the book's sheets 102 and marking instruments 108 cooperatively enable any markings on the sheets, including, without limitation, coloring of the line art images, to be erased with a dry cloth, paper towel, eraser, or other similar article so that the user may repeatedly perform a cycle of making markings on the sheets 102 and erasing the markings to prepare the sheets 102 for reuse. The marking instruments 108, generally, include appropriate pens, pencils, crayons, markers, chalk, and other similar articles cooperative with the sheets 102 to enable marking, erasure, and reuse of the sheets 102 absent material degradation of the sheets 102.

A portion of the book's sheets 102 have shoulders 112 which are cooperatively positioned and shaped to extend partially around the receptacle 110. The shoulders 112 enable the receptacle 110 to protrude relative to those sheets 102 so that the receptacle 110 is not covered over, or hidden from view, by any such sheets 102. Because the receptacle 110 is not covered over, the receptacle 110 and the marking instruments 108 stored therein may be readily viewed by the user and are readily accessible for use when the book 100 is in a closed state or open to any of those sheets 102 without requiring the user to move, or turn, a sheet 102 in order to see or gain access to the receptacle 110. As a consequence of being able to see the receptacle 110 and having easy access to it, the user is encouraged to be more creative and to employ marking instruments 108 which produce different colors while marking on the sheets 102. The shoulders 112 define notches 113 (also referred to herein as “cut-outs 113”) extending through the respective sheets 102 which receive the receptacle 110 therein.

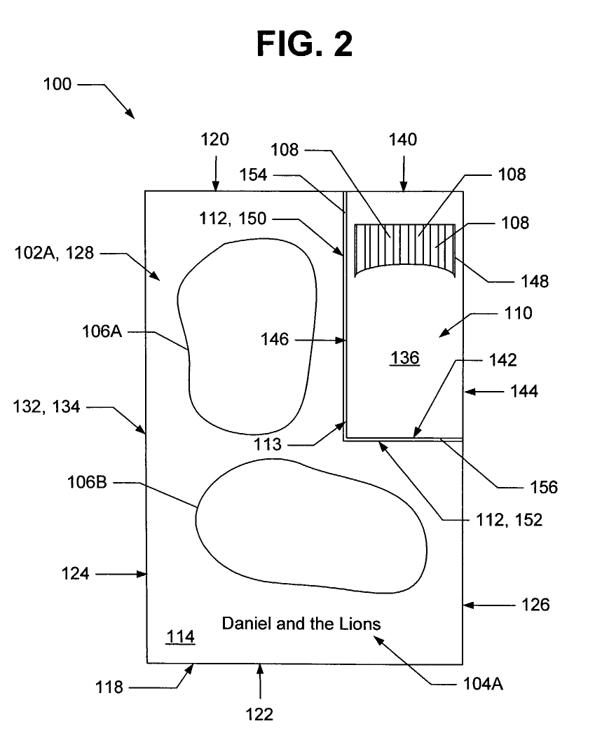

Each sheet 102 of the plurality of sheets 102 has front and back surfaces 114, 116 which extend to an edge surface 118 (also referred to herein a “edge 118”) that defines the perimeter, or periphery, of the sheet 102. The perimeter of each sheet 102 has a, generally, rectangular shape (i.e., when viewed from the front as in FIG. 2) such that each sheet 102 has a top 120, bottom 122, left side 124, and right side 126. The plurality of sheets 102 includes first and second sheets 102A, 102B which comprise front and back covers 128, 130 of the book 100, respectively. The remaining sheets 102 of the plurality of sheets 102 comprise intermediate sheets 102C which are present between front and back covers 128, 130. The front and back covers 128, 130 and intermediate sheets 102C are held together by a binding 132 which extends substantially adjacent to the left side 124 of each sheet 102 and which forms the book's spine 134. The binding 132 allows the front and back covers 128, 130 and intermediate sheets 102C to be moved, or more particularly, rotated relative to, or about, the longitudinal axis of the spine 134 so as to enable the user to “open” the book's front cover 128 and “turn” from sheet 102 to sheet 102, thereby exposing a desired surface 114, 116 of a sheet 102. It should be understood that even though FIG. 1 displays only two intermediate sheets 102C, the scope of the present invention includes books 100 which may include a greater or lesser number of intermediate sheets 102C or, perhaps, no intermediate sheets 102. The scope of the present invention also includes books 100 having sheets 102 with non-rectangular shapes and having other structures and/or methods for holding the sheets 102 together which may be available now or in the future.

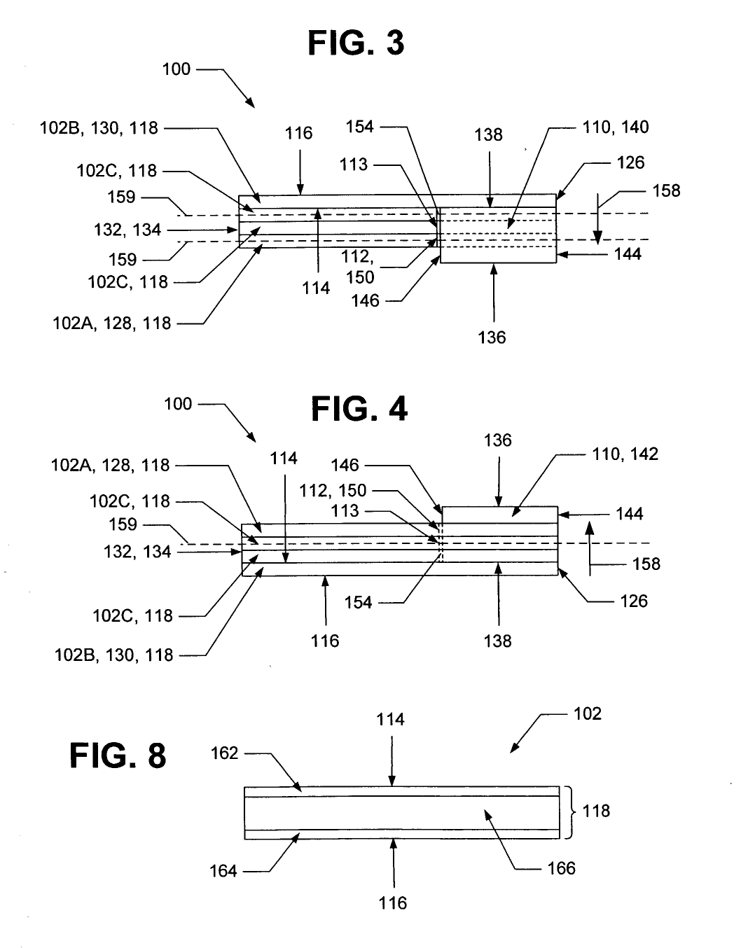

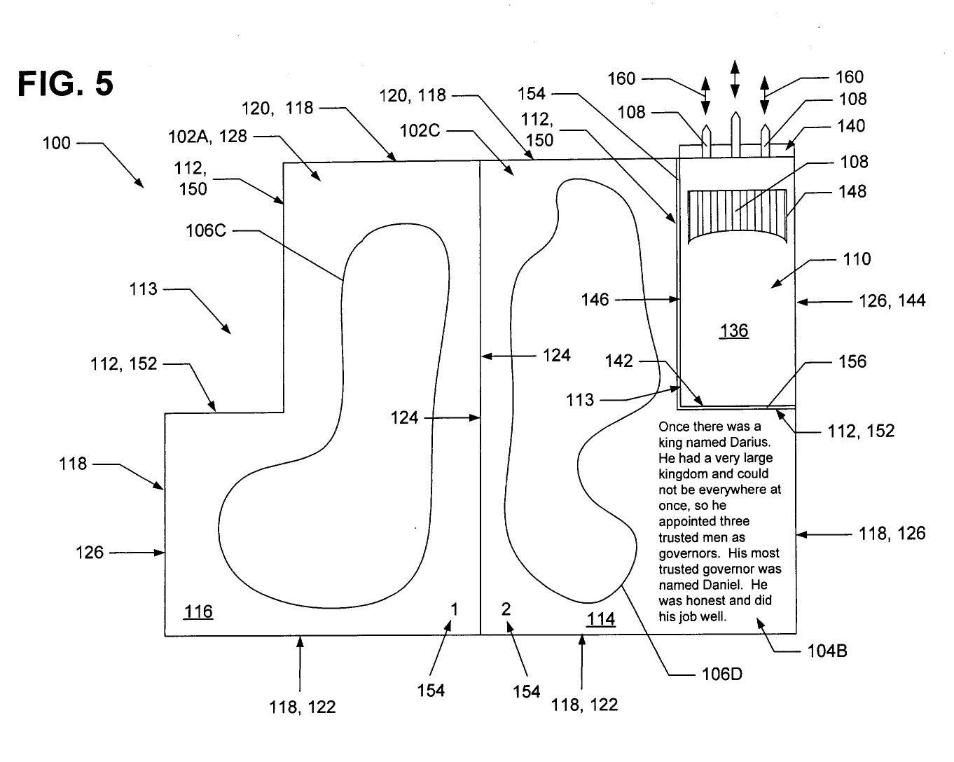

The book's sheets 102, similar to the sheets of any book, may be positioned by the user in a variety of states, conditions, or orientations by rotating, or turning, the front cover 128 and/or intermediate sheets 102C about the longitudinal axis of the book's spine 134. In the closed state displayed in FIGS. 2, 3, and 4, the book's front cover 128, intermediate sheets 102C, and back cover 130 are each positioned substantially parallel, atop, and adjacent one another. In fully-open states, the book's front cover 128 is positioned in a fully-opened position substantially coplanar with the book's back cover 130 as illustrated in FIGS. 5, 6, and 7. In a partially open state as depicted in FIG. 1, the book's front cover 128 is positioned between a fully-opened position substantially coplanar with the book's back cover 130 and a closed position substantially parallel and atop the back cover 130.

The receptacle 110, according to the first embodiment and as displayed in FIG. 1, includes a box-type structure having a front panel 136, back panel 138, top panel 140, bottom panel 142, right side panel 144, and left side panel 146. The front panel 136 is visible, by virtue of the shoulders 112 and notches 113 described herein, from the book's front (see FIG. 2) and defines an opening 148 extending therethrough which enables a user to view the marking instruments 108 present in the receptacle 110 with the book 100 either closed or open to any sheet 102. The receptacle's back panel 138 is affixed to the front surface 114 of the book's back cover 130 in a position in which the receptacle's top panel 140 and right side panel 144 are substantially aligned, respectively, with the top 120 and right side 126 of each sheet 102. Preferably, the receptacle's back panel 138 is affixed to the book's back cover 130 with an adhesive substance, thereby securing the receptacle 110 to the book 100. The receptacle's top panel 140 is hingedly connected to the remainder of the receptacle 110, enabling the top panel 140 to be opened for the removal and/or re-insertion of marking instruments 108 into the receptacle 110 (see FIGS. 5, 6, and 7) and to be closed thereafter.

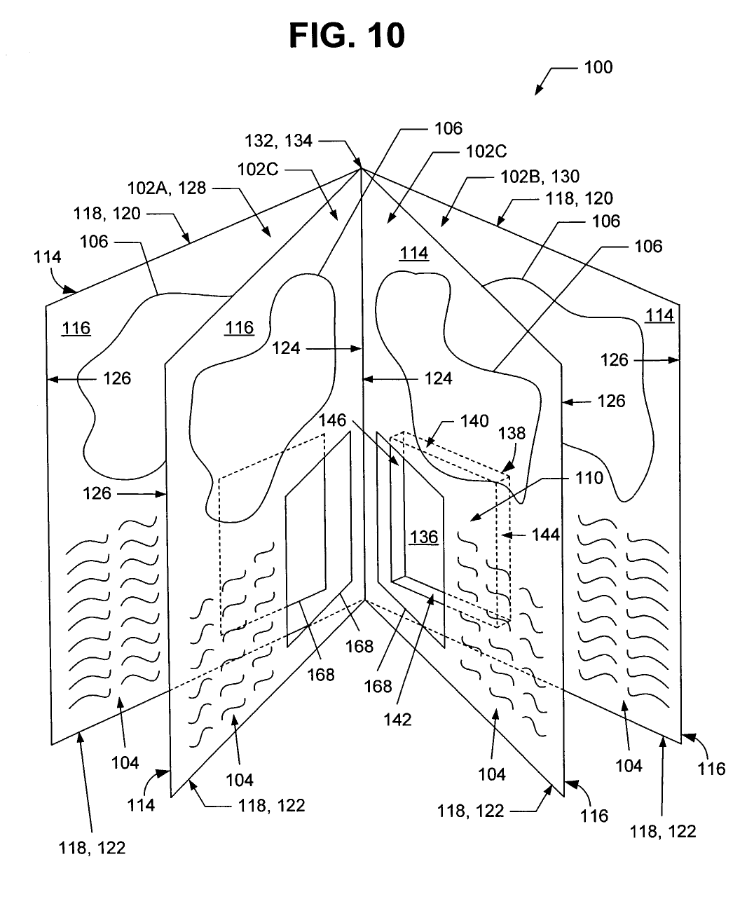

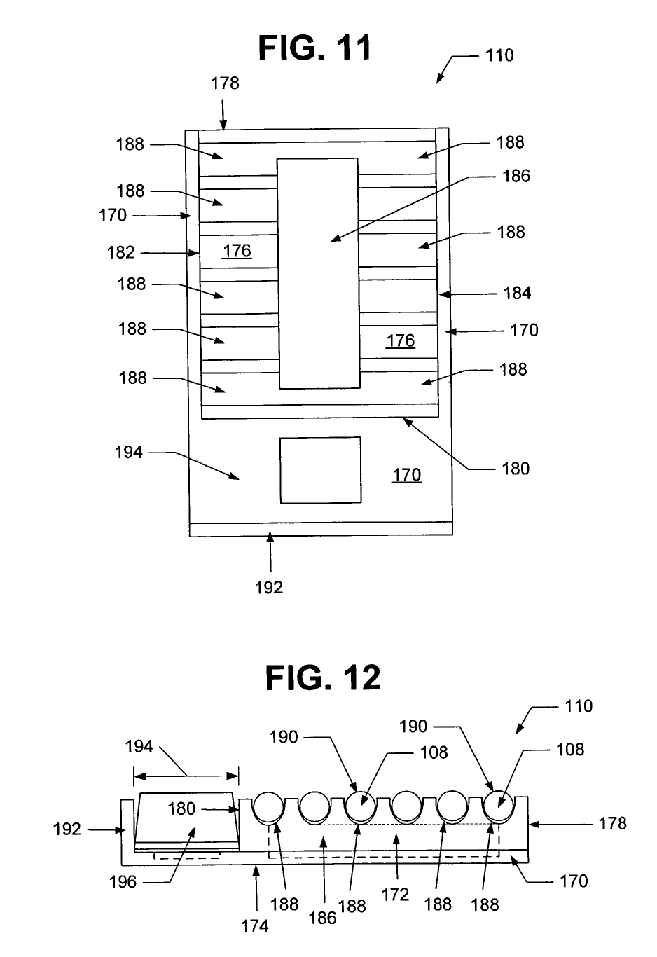

A receptacle 110, acceptable in accordance with the first embodiment, includes a paperboard or cardboard box. It should be understood, however, that the receptacle 110 may take the form of a variety of boxes or non-box type holders (i.e., one such non-box type holder is described below with reference to FIGS. 10 and 11), a variety of shapes, and may be affixed to one of the book's covers 128, 130 or intermediate sheets 102C using a variety of other substances, structures, or methods including, but not limited to, hook and loop fasteners, double-sided tape, tabs/slots, tongues, flaps, straps, and clips. Such non-box type holders may also include bags or pouches. It should additionally be understood that the receptacle 110 may be formed as an integral structure with one of the book's covers 128, 130 or intermediate sheets 102C, thereby negating the necessity of having to affix the receptacle 110 to the book's back cover 130.

The respective edges 118 of the book's front cover 128 and intermediate sheets 102C each have edge portions 150, 152 which define the shoulders 112 and notches 113 thereof. When the front cover 128 and/or intermediate sheets 102C are in a closed state as illustrated in FIG. 2, their edge portions 150, 152 reside, respectively, substantially adjacent to the receptacle's left side panel 146 and bottom panel 142. Similarly, when the book's front cover 128 is opened to reveal intermediate sheets 102C positioned atop the book's back cover 130 and having page numbers 154, as displayed in FIGS. 5, 6, and 7, the respective edge portions 150, 152 of the intermediate sheets 102C (i.e., identified by page numbers 154 having numerals “2”, “4”, and “6”) reside substantially adjacent to the receptacle's left side and bottom panels 146, 142.

The dimensions of the edge portions 150, 152 (and, hence, the dimensions of shoulders 112 and notches 113) are, preferably, sized relative to the dimensions of the receptacle 110 such that, in the book's closed state, the front cover 128, the intermediate sheets 102C, and the receptacle 110 cooperatively define a first plurality of gaps 154 and a second plurality of gaps 156 therebetween. The first plurality of gaps 154 is defined between respective edge portions 150 of the front cover 128 and intermediate sheets 102C and the receptacle's left side panel 146. The second plurality of gaps 156 is defined between respective edge portions 152 of the front cover 128 and intermediate sheets 102C and the receptacle's bottom panel 142. The presence of the gaps 154, 156 (see FIG. 2) allows respective edge portions 150, 152 of the front cover 128 and intermediate sheets 102C (and, hence, shoulders 112) to reside substantially adjacent to the receptacle's left side panel 146 and bottom panel 142 without contacting the receptacle 110, thereby enabling the front cover 128 and intermediate sheets 102C to move, or turn, easily without binding with the receptacle 110 when they are moved, or turned, about the longitudinal axis of the book's spine 134 between the closed state and any open state.

The shoulders 112 and notches 113 of the front cover 128 and intermediate sheets 102C, as briefly described above, allow the receptacle 110 to extend, or protrude, relative to the book's front cover 128 and intermediate sheets 102C in a direction perpendicular to the book's back cover 130 and toward the book's front cover 128 (i.e., indicated by arrow 158). The shoulders 112 and notches 113 also allow the receptacle 110 to protrude through planes 159 defined by the front cover 128 and each intermediate sheet 102C, respectively. Preferably, as illustrated in FIGS. 2, 3, and 4, the receptacle 110 protrudes through the notches 113 beyond the book's front cover 128, as evidenced by the front surface 114 of the book's front cover 128 being less distant, in the direction indicated by arrow 158, from the book's back cover 130 than the receptacle's front panel 136. The protrusion of the receptacle 110 makes the receptacle 110 and the marking instruments 108 stored therein more visible and readily accessible to the user. Such accessibility enables the user to easily remove and/or re-insert marking instruments 108 from/into the receptacle 110, as indicated by arrows 160 in FIGS. 5, 6, and 7, absent movement of the front cover 128 or any intermediate sheet 102C and regardless of whether the book 100 is an open or closed state. It should be understood, however, that in various forms of the present invention, the front surface 114 of the book's front cover 128 may be equidistant, or less distant, from the book's back cover 130 in the direction indicated by arrow 158.

Each of the book's sheets 102, according to the first embodiment, comprises a multi-ply, composite, rigid, sandwich-like structure having first and second outer plies 162, 164 and a third, inner ply 166 as displayed in FIG. 8. The first and second outer plies 162, 164 form surfaces 114, 116 of the sheets 102 which are visible to the book's user and on which markings may be made by the user through use of the marking instruments 108 held in receptacle 110. The first and second outer plies 162, 164 are manufactured from a material which enables a user to mark on a surface 114, 116 with a marking instrument 108 and, thereafter, to erase or remove the marking from the surface 114, 116 by rubbing the marking and surface 114, 116 with a dry cloth, eraser, or other suitable dry article absent degradation to the surface 114, 116. Such a surface 114, 116 is commonly referred to as a “wipe-on, wipe-off” surface. An acceptable material for the first and second outer plies 162, 164 includes laminate, generally, available under the “Dry-Erase” trademark. Marking instruments 108 which are acceptable according to the first embodiment include crayons also, generally, available under the “Dry-Erase” trademark. The third, inner ply 166 of each sheet 102 is, preferably, formed from a material having sufficient rigidity in a suitable thickness to enable a user to press down on a sheet 102 with a reasonable amount of pressure during marking thereon without deforming or damaging the sheet 102. A material acceptable for the third, inner ply 166 includes, for example and not limitation, the material commonly referred to as “cardboard”. Each of the first and second outer plies 162, 164 and third ply 166 have respective thicknesses, and, together, form edge surface 118. It should be realized that the sheets 102 and marking instruments 108 may be manufactured using other materials and methods having similar characteristics.

Each of the book's sheets 102 also, generally, includes text 104, a graphical image 106, or a combination or multiples thereof which are pre-printed during manufacture on the front and back surfaces 114, 116 of the sheets 102 in permanent, non-erasable ink. For example, front surface 114 of the book's front cover 128 (i.e., sheet 102A), as displayed in FIG. 2, includes text 104A thereon representative of the book's title and includes graphical images 106A, 106B thereon which, respectively, constitute a trademark logo of the manufacturer and an illustration associated with the title and the story presented by the book 100. As illustrated in FIG. 5, the graphical images 106 associated with the book's story begin on the back surface 116 of the book's front cover 128 (i.e., identified by a page number 154 having the numeral “1”, while the story begins on the front surface 116 of the first intermediate sheet 102C (i.e., identified by a page number 154 having the numeral “2”). Thus, the back surface 116 of the book's front cover 128 includes graphical image 106C, and the front surface 114 of the intermediate sheet 102C includes textual passage 104B representing a portion of the story and graphical image 106D associated, preferably, with the textual passage 104B. Graphical images 106C and 106D, preferably, includes line art which provides outlines between which the book's user may color with a marking instrument 108. The presence of the outlines aids in improving the user's eye/hand coordination and dexterity as the user attempts to color between the outlines. The user may, if desired, also mark, draw, write, or print on other areas of the back surface 116.

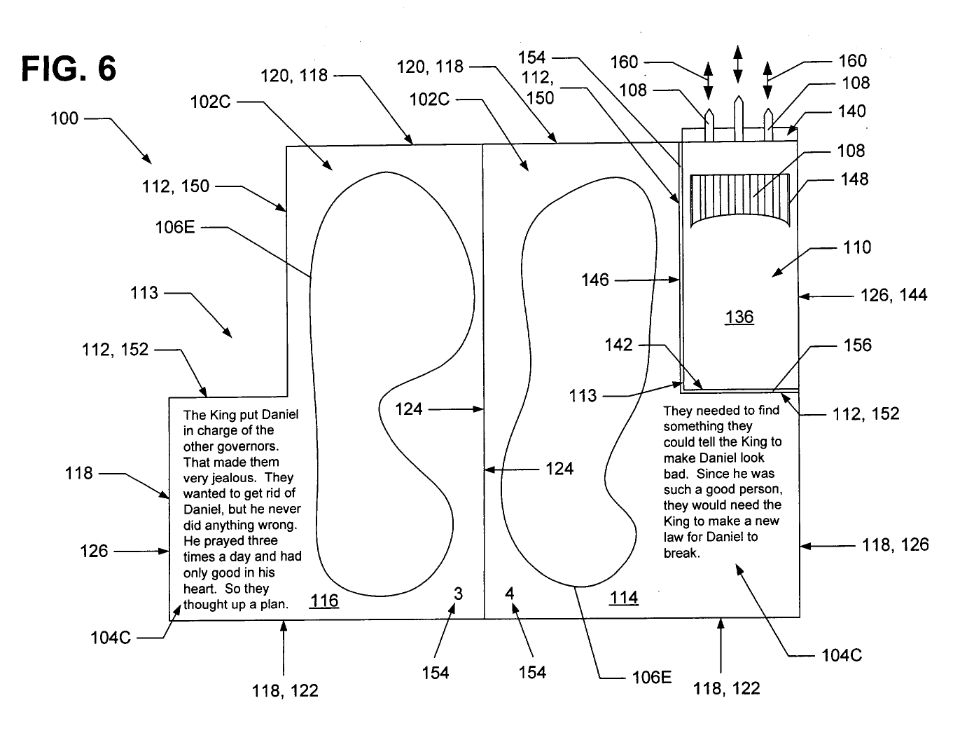

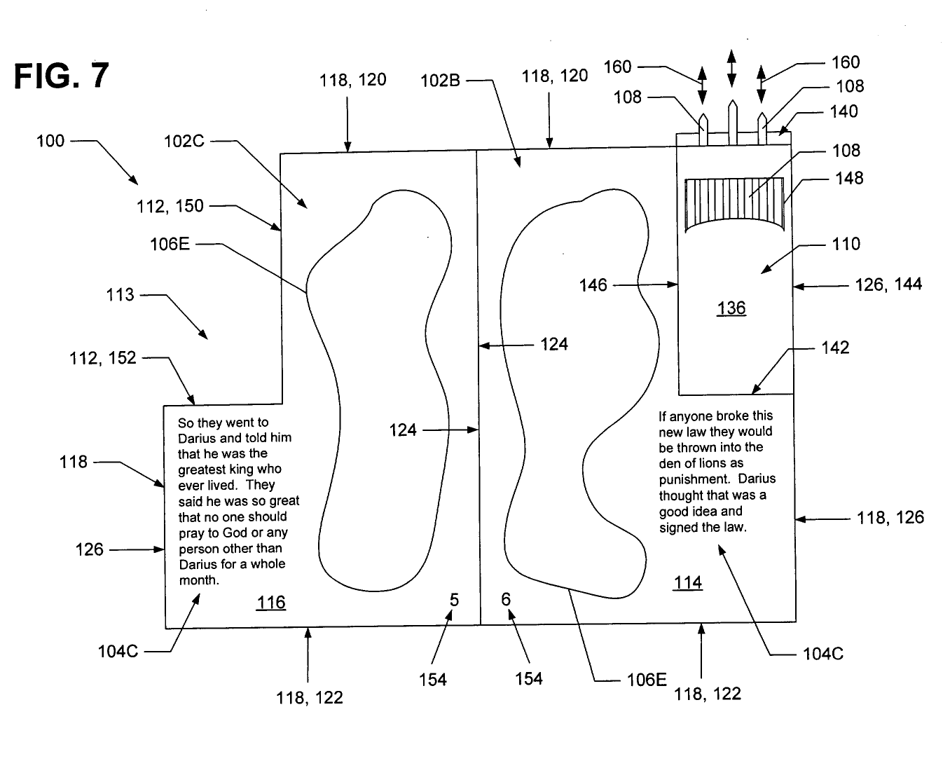

Similarly, as displayed in FIGS. 6 and 7, the front and back surfaces 114, 116 of the intermediate sheet 102C and the front surface 114 of the back cover 130 include text 104C representing different portions of the book's story and graphical images 106E and associated, preferably, with such text 104C. The graphical images 106E, like that on the back surface 116 of the book's front cover 128, include line art having outlines within which a user may attempt to color with a marking instrument 108. The user may also mark, draw, write, or print in other areas of the intermediate sheets 102C. The back surface 116 of the book's back cover 130, although not visible in the figures hereof, includes text comprising instructions related to the book's use, advertisements identifying other books in a series of similar books, and various legal notices. Additionally, the back surface 116 of the book's back cover 130 also includes graphical images corresponding to the manufacturer's trademark logo and associated with the instructions to illustrate the book's use. It should be understood that the scope of the present invention also includes sheets 102 which include text alone, graphical images alone, combinations of text and graphical images, no text, or no graphical images. It should also be understood that the scope of the present invention includes a series of books 100 substantially similar to book 100 of the first embodiment which, respectively, present different stories, have different titles, textual passages 104, and graphical images 106.

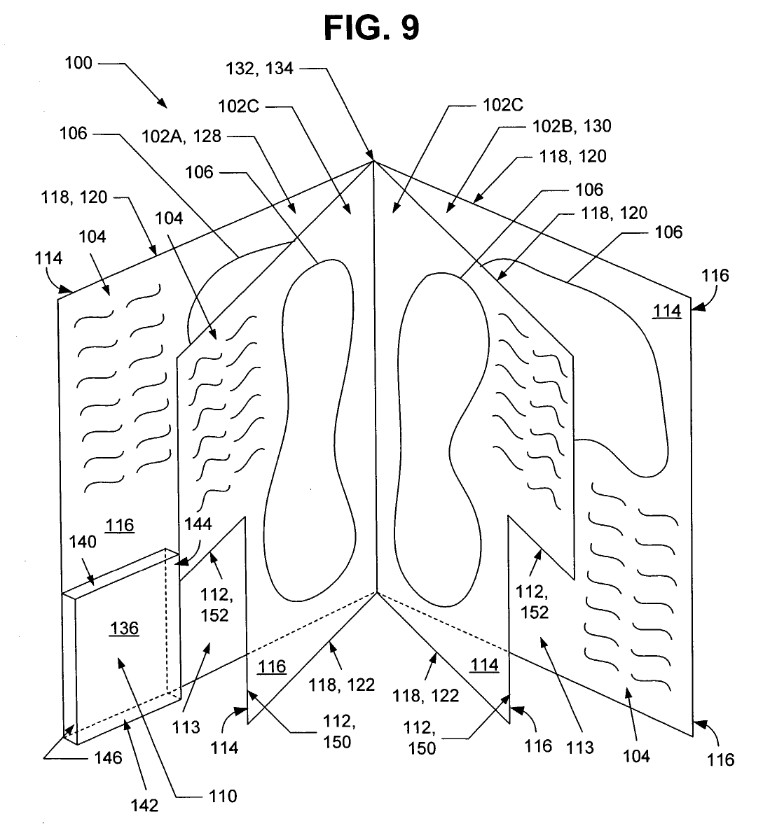

According to a second embodiment of the present invention displayed in FIG. 9, a book 100 comprises elements substantially similar to the book 100 of the first embodiment. However, in the book 100 of the second embodiment, the receptacle 110 for marking instruments 108 is secured to the back surface 116 of the book's front cover 128 at a lower left comer thereof. In cooperation with the receptacle 110, the book's intermediate sheets 102C define shoulders 112 and notches 113 at their lower comers opposite the book's spine 134 so that the receptacle 110 protrudes rearward through the book 100 relative to the intermediate sheets 102C thereof. The shoulders 112, notches 113, and protrusion of the receptacle 110, similar to the first embodiment albeit in the opposite direction, prevent the intermediate sheets 102C from covering over the receptacle 110 and enable the book's user to view the receptacle 110 and access the marking instruments 108 therein with the book 100 open to any sheet 102, absent turning of any intermediate sheets 102 to expose the receptacle 110.

In accordance with a third embodiment of the present invention, a book 100 comprising elements substantially similar to those of the book 100 of the first embodiment is illustrated in FIG. 10. However, the book 100 of the third embodiment includes a receptacle 110 for storing marking instruments 108 which is secured to the front surface 114 of the back cover 130 at a location intermediate the back cover's top 120 and bottom 122 and intermediate the back cover's left and right sides 124, 126. The book 100 of the third embodiment further comprises a front cover 128 and intermediate sheets 102C which define respective openings 168 therethrough. The openings 168, similar to the shoulders 112 of the first embodiment, are sized and positioned relative to the book's receptacle 110 such that receptacle 110 protrudes through the openings 168 when the front cover 128 and/or intermediate sheets 102C are positioned parallel to or atop the book's back cover 130. The openings 168 and protrusion of the receptacle 110 therethrough cooperatively prevent the book's front cover 128 or any intermediate sheet 102C thereof from covering over the receptacle 110. As a consequence, the receptacle 110 and the marking instruments therein, similar to the receptacle 110 and marking instruments 108 of the first embodiment, are accessible to a user with the book 100 in a closed state or in any open state and without the user having to turn a sheet 102 in order to expose the receptacle 110 or gain access to the marking instruments 108.

As described above with respect to the various embodiments of the present invention, the receptacle 110 comprises, generally, a box-type structure having a top panel 140 hingedly connected to the remainder of the receptacle 110, which is opened by the user in order to remove or re-insert marking instruments 108. It should be understood, however, that the scope of the present invention includes other forms of receptacles 110 which may be employed as alternatives to receptacles 110 having a box-type structure. FIGS. 11 and 12 display such an alternative receptacle 110 in respective front and right side elevational views thereof. The receptacle 110 of FIGS. 11 and 12 comprises a unitary, tray-type structure which is, preferably, molded from a plastic material that is flexible to enable the insertion and capture of marking instruments 108 therein, yet of sufficient durability and acceptable impact resistance. The receptacle 110 includes a base portion 170 and a tray portion 172 integral therewith for holding marking instruments 108. The base portion 170 has a substantially flat back surface 174 which, when secured to a front cover 128, back cover 130, or intermediate sheet 102C of a book 100, resides substantially adjacent thereto and is affixed, for example and not limitation, by an adhesive substance, double-sided tape, hook and loop fasteners, or other substance or structure capable of securing the receptacle 110 to the front cover 128, back cover 130, or intermediate sheets 102C.

The receptacle's tray portion 172 has a front surface 176 and top, bottom, left, and right side surfaces 178, 180, 182, 184 which extend between the front surface 176 and base portion 170. The distance between the left and right side surfaces 182, 184 is configured to substantially match the length of the marking instruments 108 which may be held by the receptacle 110. The tray portion's front surface 176, as illustrated in FIGS. 11 and 12, defines a depression 186 therein disposed substantially central to the top, bottom, left, and right side surfaces 178, 180, 182, 184. The receptacle's front surface 176 further defines a plurality of recesses 188 therein which have a, generally, arcuate shape and that are arranged in pairs, so that the recesses 188 in each pair of recesses 188 are collinearly aligned to receive a marking instrument 108. Each recess 188 extends, respectively, between either of the receptacle's left and right side surfaces 182, 184 and depression 186. Notably, however, the left and right side surfaces 182, 184 do not cover the ends of the recesses 188 nearest the left and right side surfaces 182, 184. The curvature of the recesses 188 is configured to substantially match the curvature of the lateral outer surfaces 190 of the marking instruments 108 which are held by the receptacle 110.

The receptacle 110 further comprises a wall 192 which protrudes from the receptacle's base portion 170 and is substantially parallel to the bottom surface 180 of the receptacle's tray portion 172. Together, the wall 192 and bottom surface 180 define a gap 194 therebetween. The distance between the wall 192 and bottom surface 180 and the depth of the gap 194 are sized appropriately to enable the gap 194 to receive and store an eraser 196. The eraser 196 is employed by the book's user to erase markings on the book's sheets 102, thereby enabling reuse of the sheets 102.

In use, marking instruments 108 are stored in the recesses 188 and may be removed from the receptacle 110 by the user grasping the desired marking instrument 108 by its ends (i.e., which is possible because the tray portion's left and right side surfaces 182, 184 do not cover the ends of the recesses 188) and exerting an upward force on the marking instrument 108 away from the tray portion's front surface 176. Exertion of the upward force causes deflection of the tray portion's front surface 176 in the area of the recess 188 holding the marking instrument 108 and enables the user to remove the marking instrument 108 from the receptacle 110. Alternatively, a desired marking instrument 108 not having an adjacent marking instrument 108 in the receptacle 110 may be removed by the user placing a finger into depression 186 and under the marking instrument 108. Upon the application of a slight amount of force to the marking instrument's lateral outer surface 190 from beneath the marking instrument 108 with the finger in a, generally, upward direction away from the receptacle 110, the tray portion's front surface 176 deflects in the area of the recess 188 in which the desired marking instrument 108 resides, thereby freeing the marking instrument 108 and allowing the user to remove the marking instrument 108 from the receptacle 110.

To insert a marking instrument 108 for storage by the receptacle 110, the user positions the marking instrument 108 substantially over a pair of recesses 188 which do not presently hold another marking instrument 108 such that the marking instrument 108 is collinearly aligned with the pair of recesses 188. Then, the user presses downward on the marking instrument's lateral outer surface 190 with a small amount of force until the tray portion's front surface 176 deflects slightly in the area of the recesses 188. Once the marking instrument 108 is pressed downward into the recess 188, the flexible, resilient nature of the tray portion's material causes the front surface 176 to “spring back” and apply a small amount of force to the outer lateral surface 190 of the marking instrument 108, thereby grasping and holding the marking instrument 108 in place.

During use, an eraser 196 is stored in gap 194 and may be removed therefrom by the user grasping the eraser 196 (perhaps, at the eraser's ends since the receptacle 110 does not cover the eraser's ends) and by then exerting a small upward force in a direction substantially away from the receptacle 110. The application of the force causes wall 192 and the bottom surface 180 of the tray portion 172 to deflect slightly, thereby enabling the eraser 196 to be pulled out of gap 194. Alternatively, the eraser 196 may be removed from the receptacle 110 by the user applying a small amount of force to one of the eraser's ends to slide the eraser 194 in the longitudinal direction of the gap 194, thereby causing the eraser 196 to slide relative to wall 192 and tray portion's bottom surface 180 in the gap's longitudinal direction and, eventually, out of the receptacle 110.

To insert an eraser 196 into the gap 194 for storage, the user positions the eraser 186 substantially over the gap 194 with the eraser's longitudinal axis aligned with the longitudinal axis of the gap 194. Then, the user applies a slight amount of downward force to the top of the eraser 196, thereby causing the tray portion's bottom surface 180 and wall 192 to deflect enough to enable the user to push the eraser 196 into the gap 194. Once in the eraser 196 is in the gap 194, the resilient nature of the receptacle's material causes the tray portion's bottom surface 180 and wall 192 to exert a force on the sides of the eraser 196 which removably secures the eraser 194 in the receptacle 110. Alternatively, the eraser 196 may be positioned at one of the gap's ends and slid into the gap 194 through the application of a small amount of force to the eraser 196 in the longitudinal direction of the gap 194 and eraser 196.

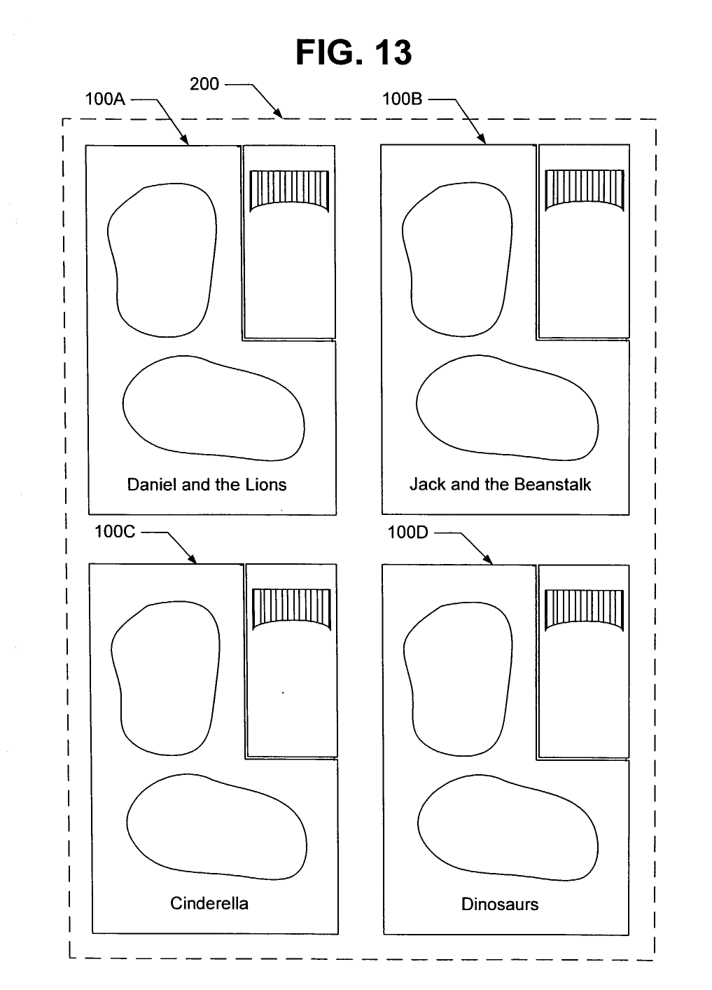

FIG. 13 displays a pictorial view of a collection 200 of books 100 according to a fourth embodiment of the present invention. The collection 200 of books 100 includes a plurality of books 100 (i.e., each book 100 being uniquely identified with an alphabetic character) which are substantially similar to book 100 of the first embodiment of the present invention. Each book 100 of the collection 200, however, has a different title, a different story, and different images for presentation to a user.

It should be understood that while the present invention has been described herein with respect to a book 100 comprising a plurality sheets 102, the scope of the present invention includes other similar articles which comprise a receptacle 110 for storing a plurality of marking instruments 108 and a plurality of sheets 102 which are cooperatively shaped relative to the receptacle 110 to allow a user to access the receptacle 110 without having to move the sheets 102. One such similar article includes a writing tablet having a plurality of sheets with one of the sheets forming a tablet back. Similar to the sheets and marking instruments of the books described herein, the sheets and marking instruments of the writing tablet are of a type which enable a user to mark, draw, color, print, or write with the marking instruments 108 and to erase such markings with a dry cloth, paper towel, or eraser. However, each sheet of such a writing tablet, preferably, includes lines imprinted thereon in permanent, non-erasable ink to provide a reference for the user to use while attempting to print or write.

Whereas this invention has been described in detail with particular reference to its most preferred embodiments, it is understood that variations and modifications can be effected within the spirit and scope of the invention, as described herein before and as defined in the appended claims. The corresponding structures, materials, acts, and equivalents of all means plus function elements, if any, in the claims below are intended to include any structure, material, or acts for performing the functions in combination with other claimed elements as specifically claimed.

What is claimed is:

1. A book, comprising:
a plurality of sheets, wherein a first sheet of said plurality of sheets has an edge extending thereabout; and,
a receptacle for storing a marking instrument, said receptacle being secured to a second sheet of said plurality of sheets and protruding from said second sheet;
wherein a portion of said edge of said first sheet is configured to extend at least partially around said receptacle.

2. The book of claim 1, wherein said first sheet is positionable in a position substantially adjacent said second sheet, and wherein said portion of said edge extends at least partially around said receptacle when said first sheet resides in said position.

3. The book of claim 1, wherein said first sheet is positionable in a position substantially adjacent said second sheet, and wherein said portion of said edge has a surface configured to reside substantially adjacent said receptacle when said first sheet resides in said position.

4. The book of claim 1, wherein said first sheet of said plurality of sheets has a surface for receiving a marking thereon from said marking instrument and for enabling erasure of said marking therefrom with a dry cloth.

5. The book of claim 1, wherein said first sheet of said plurality of sheets has a surface commonly referred to as a dry-erase surface.

6. The book of claim 1, wherein said first sheet of said plurality of sheets has a surface for receiving a marking thereon from said marking instrument and for enabling erasure of said marking therefrom absent degradation of said surface.

7. The book of claim 1, wherein said first sheet is positionable in a position substantially adjacent said second sheet, and wherein said receptacle is visible to a user when said first sheet resides in said position.

8. The book of claim 1, wherein said first sheet is positionable in a position substantially adjacent said second sheet, and wherein said receptacle is accessible to a user absent movement of said first sheet when said first sheet resides in said position.

9. The book of claim 1, wherein said first sheet is positionable in a position substantially adjacent said second sheet, and wherein said receptacle protrudes relative to said first sheet when said first sheet resides in said position.

10. The book of claim 1, wherein said first sheet comprises a front cover.

11. The book of claim 1, wherein a third sheet of said plurality of sheets comprises a front cover, said second sheet of said plurality of sheets comprises a back cover, and said first sheet of said plurality of sheets comprises an intermediate sheet positioned between said second sheet and said third sheet.

12. The book of claim 1, wherein said first sheet of said plurality of sheets includes text thereon corresponding to a portion of a story.

13. The book of claim 1, wherein said first sheet of said plurality of sheets includes a graphical image thereon associated with a story.

14. The book of claim 13, wherein said graphical image includes line art.

15. A book, comprising:
a plurality of sheets, wherein a first sheet of said plurality of sheets has a surface adapted to receive a marking from a marking instrument and to enable erasure of said marking therefrom with a dry cloth; and,
a holder for storing a marking instrument, said holder being secured to a second sheet of said plurality of sheets.

16. The book of claim 15, wherein said first sheet of said plurality of sheets has a shoulder for receiving said holder.

17. The book of claim 16, wherein said shoulder is positionable to reside substantially adjacent said holder.

18. The book of claim 16, wherein said shoulder is positionable to extend at least partially around said holder.

19. The book of claim 15, wherein said first sheet is positionable in a position substantially parallel to said second sheet, wherein said first sheet has a surface substantially parallel to said second sheet and located at a first distance relative to said second sheet when said first sheet is in said position, and wherein said holder has a panel substantially parallel to said second sheet and located at a second distance relative to said second sheet, said second distance being greater than said first distance.

20. The book of claim 15, wherein said first sheet is positionable in a position substantially parallel to said second sheet, wherein said first sheet has a surface substantially parallel to said second sheet and located at a first distance relative to said second sheet when said first sheet is in said position, and wherein said holder has a panel substantially parallel to said second sheet and located at a second distance relative to said second sheet, said second distance being equal to said first distance.

21. The book of claim 15, wherein said first sheet of said plurality of sheets includes text thereon corresponding to a portion of a story.

22. The book of claim 15, wherein said first sheet of said plurality of sheets includes a graphical image thereon associated with a story.

23. The book of claim 15, wherein said first sheet of said plurality of sheets includes line art thereon associated with a story.

24. The book of claim 15, wherein said surface of said first sheet of said plurality of sheets is commonly referred to as a wipe-on, wipe-off surface.

25. The book of claim 16, wherein said first sheet is positionable in a position substantially parallel to said second sheet, and wherein said holder is visible to a user adjacent said shoulder when said first sheet resides in said position.

26. The book of claim 15, wherein said first sheet is positionable in a position substantially parallel to said second sheet, and wherein said holder is accessible to a user absent movement of said first sheet when said first sheet resides in said position.

27. A book, comprising:
a first cover;
a second cover;
a receptacle for storing a marking instrument, said receptacle being attached to said second cover and protruding from said second cover in a direction toward said first cover; and,
a sheet intermediate said first cover and said second cover, said sheet having a cut-out therein, said cut-out being adapted to receive said receptacle at least partially therein.

28. The book of claim 27, wherein said receptacle is positioned substantially at a corner of said second cover, and wherein said sheet defines said cut-out at a corresponding location of said sheet.

29. The book of claim 27, wherein said cut-out and said receptacle have shapes cooperative to enable said cut-out to receive said receptacle at least partially therethrough.

30. The book of claim 27, wherein said sheet has an edge portion which defines said cut-out, said edge portion being positionable to reside substantially adjacent said receptacle.

31. The book of claim 27, wherein said sheet has an edge portion which defines said cut-out, said edge portion being positionable to extend at least partially around said receptacle.

32. The book of claim 27, wherein said sheet has an edge extending around the periphery thereof, said edge being shaped to extend at least partially around said receptacle.

33. The book of claim 27, wherein said sheet is substantially rigid and defines a plane, wherein said sheet is positionable in a position substantially parallel to said second cover, and wherein said receptacle protrudes at least partially through said plane when said sheet is positioned in said position.

34. The book of claim 27, wherein said cut-out enables said receptacle to be viewable by a user therethrough.

35. The book of claim 27, wherein said sheet is positionable in a position substantially parallel to said second cover, and wherein said cut-out substantially prevents said sheet from covering said receptacle when said sheet is positioned in said position.

36. The book of claim 27, wherein said cut-out allows said receptacle to be accessible therethrough.

37. The book of claim 27, wherein said first cover defines a cut-out therein, said cut-out of said first cover being adapted to receive said receptacle at least partially therein.

38. The book of claim 37, wherein said receptacle and said cut-out of said first cover are positioned at corresponding locations which enable said receptacle to protrude at least partially therethrough.

39. The book of claim 27, wherein said sheet has a surface which enables a marking thereon by said marking instrument to be removed therefrom absent degradation of said surface.

40. The book of claim 27, wherein said sheet has a surface which enables a marking thereon by said marking instrument to be removed by rubbing said marking with a dry cloth.

41. The book of claim 27, wherein said marking instrument is adapted to produce a marking on said sheet which is removable therefrom by rubbing said marking with a dry cloth.

42. The book of claim 27, wherein said receptacle includes a box-type structure.

43. The book of claim 27, wherein said sheet includes a graphical image thereon associated with a story.

44. The book of claim 43, wherein said graphical image includes line art.

45. The book of claim 27, wherein said intermediate sheet includes text thereon corresponding to a portion of a story.

46. The book of claim 27, wherein said first cover comprises a front cover, and said second cover comprises a back cover.

47. A collection of books, comprising:
a first book configured to present a first story to a user thereof; and,
a second book configured to present a second story to a user thereof;
wherein each of said first book and said second book includes a first cover, a second cover, a sheet intermediate said first cover and said second cover, and a holder for receiving a marking instrument, said holder being secured to said second cover; and,
wherein said sheet has a shape adapted to extend at least partially around said holder.

48. The collection of claim 47, wherein said sheet includes has a surface adapted to receive a marking from said marking instrument and to enable erasure of said marking therefrom with a dry cloth.

49. The collection of claim 47, wherein said sheet includes text thereon.

50. The collection of claim 47, wherein said sheet includes line art thereon.

51. A book, comprising:
a plurality of sheets, wherein a first sheet of said plurality of sheets defines an opening extending therethrough; and,
a receptacle for storing a marking instrument, said receptacle being secured to a second sheet of said plurality of sheets and protruding from said second sheet;
wherein said first sheet is positionable in a position substantially adjacent said second sheet, and wherein said receptacle extends at least partially through said opening when said first sheet resides in said position.

52. The book of claim 51, wherein said first sheet of said plurality of sheets has a surface for receiving a marking thereon from said marking instrument and for enabling erasure of said marking therefrom with a dry cloth.

53. The book of claim 51, wherein said receptacle is accessible to a user absent movement of said first sheet when said first sheet resides in said position.

54. The book of claim 51, wherein said first sheet of said plurality of sheets includes text thereon.

55. The book of claim 51, wherein said first sheet of said plurality of sheets includes a graphical image thereon.

56. The book of claim 51, wherein said opening and said receptacle have shapes cooperative to enable said opening to receive said receptacle at least partially therethrough.

57. The book of claim 51, wherein said opening enables said receptacle to be viewable by a user therethrough.
